(19) United States
(12) Patent Application Publication
(10) Pub. No.: US 2026/0218396 A1
(43) Pub. Date: Jul. 30, 2026

(54) INTEGRATED ELECTROLYZER AND ABSORPTION CHILLER SYSTEM AND METHODS OF OPERATING THE SAME

(71) Applicant: Bloom Energy Corporation, San Jose, CA (US)

(72) Inventors: Ryan JOHNSON, San Jose, CA (US); Lorenzo PENNA, San Jose, CA (US); Ashutosh SHARMA, San Jose, CA (US); David WEINGAERTNER, Sunnyvale, CA (US); Javad ASADI, San Jose, CA (US)

(21) Appl. No.: 19/451,403

(22) Filed: Jan. 16, 2026

Related U.S. Application Data
(60) Provisional application No. 63/749,741, filed on Jan. 27, 2025.

(51) Int. Cl. C25B 9/67; B01D 53/26; C25B 1/042; C25B 9/70; C25B 15/08; F25B 15/00

(52) U.S. Cl. CPC C25B 9/67; B01D 53/265; C25B 1/042; C25B 9/70; C25B 15/085; B01D 2256/16; B01D 2257/80; F25B 15/00

(57) ABSTRACT

A system includes an electrolyzer cell system configured to receive a steam inlet stream and an air inlet stream and to generate a hydrogen containing product stream and an air exhaust stream, and an absorption chiller fluidly connected to the electrolyzer cell system. The absorption chiller is configured to receive the air exhaust stream and to cool the hydrogen containing product stream using heat from the air exhaust stream.

### FIELD

Aspects of the present disclosure relate to electrochemical cell systems and methods of operating thereof, and more particularly, to an integrated electrolyzer and absorption chiller system.

### BACKGROUND

Electrochemical cells, such as solid oxide fuel cells or solid oxide electrolyzer cells, are electrochemical devices which can convert energy stored in fuels to electrical energy or to convert steam to a hydrogen product using electrical energy, respectively.

### SUMMARY

According to one embodiment, a system includes an electrolyzer cell system configured to receive a steam inlet stream and an air inlet stream and to generate a hydrogen containing product stream and an air exhaust stream, and an absorption chiller fluidly connected to the electrolyzer cell system. The absorption chiller is configured to receive the air exhaust stream and to cool the hydrogen containing product stream using heat from the air exhaust stream.

According to another embodiment, a method includes providing a steam inlet stream and an air inlet stream to an electrolyzer cell system to generate a hydrogen containing product stream and an air exhaust stream; providing the air exhaust stream to an absorption chiller to cool a cooling fluid in the absorption chiller using heat from the air exhaust stream; and cooling the hydrogen containing product stream by heat exchange with the cooling fluid provided from the absorption chiller.

### BRIEF DESCRIPTION OF THE DRAWINGS

The accompanying drawings, which are incorporated herein and constitute part of this specification, illustrate example embodiments of the invention, together with the general description given above and the detailed description given below.

FIG. 1A is a schematic block diagram illustrating an integrated electrolyzer and absorption chiller system according to various embodiments of the present disclosure.

FIG. 1B is a schematic block diagram illustrating an integrated electrolyzer and absorption chiller system according to various embodiments of the present disclosure.

FIG. 2A is a perspective view of the integrated electrolyzer and absorption chiller system according to various embodiments of the present disclosure.

FIG. 2B is a top view of the system of FIG. 2A.

FIG. 2C is a side view of the system of FIG. 2A.

FIG. 3 is a schematic block diagram illustrating components of an absorption chiller according to various embodiments of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

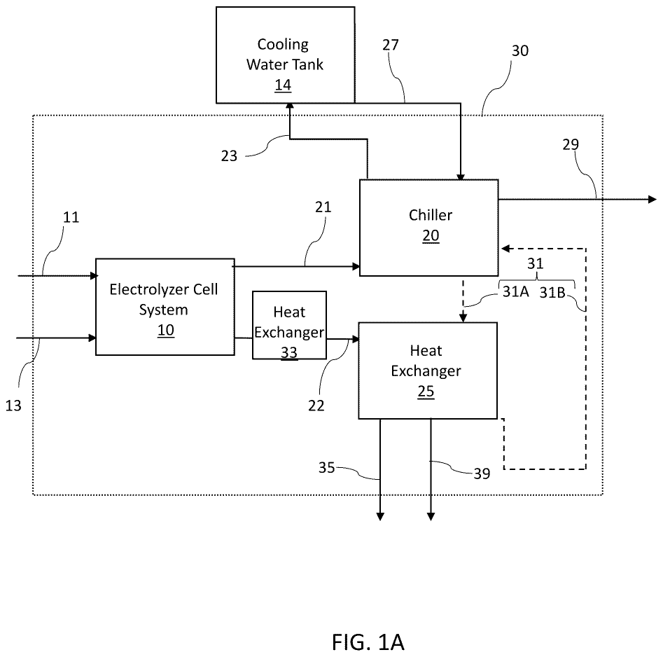

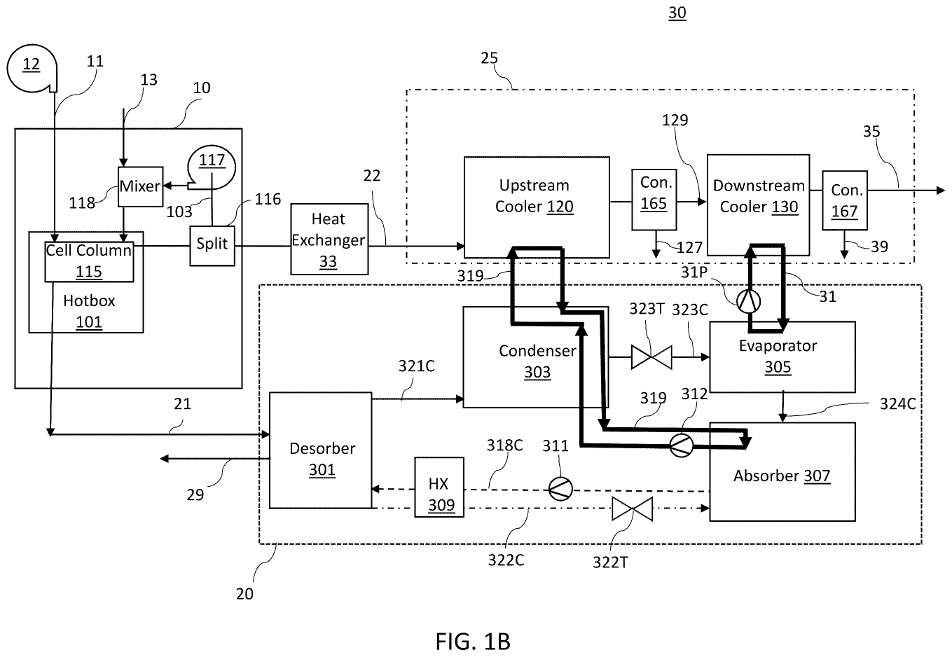

FIG. 1A is a schematic block diagram illustrating an integrated electrolyzer and absorption chiller system 30, according to various embodiments of the present disclosure. Referring to FIG. 1A, the system 30 may include an electrolyzer cell system 10 configured to generate a hydrogen containing product stream from steam, and an absorption chiller 20 fluidly connected to the electrolyzer cell system 10. As used herein, “fluidly connected” means that fluids (e.g., liquids and/or gases) can flow (e.g., through conduits, such as pipes and/or manifolds) between the two components of the system.

The electrolyzer cell system 10 may include one or more electrolyzer modules, each including a cabinet housing a hotbox. The hotbox contains one or more electrolyzer cell columns. The electrolyzer cell columns may comprise any suitable electrolyzer cells, such as solid oxide electrolyzer cells (SOECs). In this case, the electrolyzer cell column comprises a SOEC column containing one or more SOEC stacks. In a SOEC, a cathode electrode is separated from an anode electrode by a solid oxide electrolyte. When a SOEC is used to produce hydrogen through electrolysis, a positive potential is applied to the air side of the SOEC and oxygen ions are transported from the fuel (e.g., steam) side to the air side. Throughout this disclosure, the SOEC anode will be referred to as the air electrode, and the SOEC cathode will be referred to as the fuel electrode. During SOEC operation, water (e.g., steam) in the fuel stream is reduced (H₂O+2e⁻→O²⁻+H₂) to form H₂ gas and O²⁻ ions, the O²⁻ ions are transported through the solid electrolyte, and then oxidized (e.g., by an air inlet stream) on the air side (O²⁻ to O₂) to produce molecular oxygen (e.g., oxygen enriched air).

An air inlet stream (e.g., sweep air stream) may be provided to the electrolyzer module(s) of the electrolyzer cell system 10 through an air inlet conduit 11. The steam inlet stream is provided to the electrolyzer module(s) of the electrolyzer cell system 10 through a steam inlet conduit 13. The steam inlet stream may emanate from an on-site steam generation system or be a by-product of another co-located industrial process. A hot oxygen rich air exhaust stream (i.e., air exhaust stream) is output from the electrolyzer cell system 10 via an air exhaust conduit 21. A hydrogen containing product stream (e.g., a stream containing hydrogen product and residual water from the steam) is output from the electrolyzer cell system 10 via a product conduit 22.

In various embodiments, and as described in further detail below, the absorption chiller 20 may provide cooling to the hydrogen containing product stream output from the electrolyzer cell system 10 using waste heat generated by the electrolyzer cell system 10. The waste heat may be output from the electrolyzer cell system 10 in the form of the oxygen rich air exhaust stream flowing through the air exhaust conduit 21 to the absorption chiller 20.

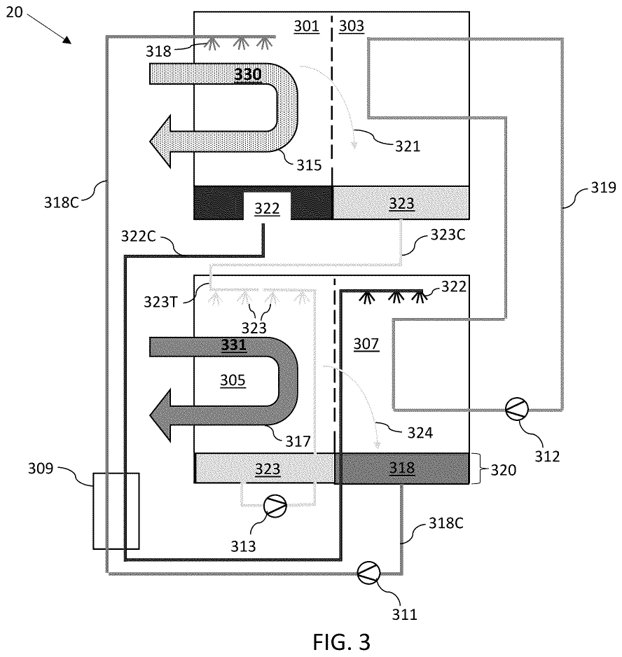

In one embodiment, the system 30 may be fluidly integrated with an optional cooling water tank 14, such as a cooling tower, where cool water may be stored at ambient temperature of the environment. A cooling loop (23, 27) connects the absorption chiller 20 and the cooling water tank 14. Heated water may flow from the absorption chiller 20 to the cooling water tank 14 through a water outlet conduit 23, while cool water may flow from the cooling water tank 14 through a water inlet conduit 27 into the absorption chiller 20. The cool water may be 5 to 20 degrees Celsius cooler than the heated water. Alternatively, the cooling water tank may be omitted and a cooling water may be circulated through a loop in the system 30 by a water pump, as will be discussed below with respect to FIGS. 1B and 3.

The absorption chiller 20 includes a working fluid. The working fluid may include any suitable working fluid, such as water or a mixture of a refrigerant and an absorbent, for example a mixture of water and lithium bromide, or a mixture of ammonia and water. The cool water from the tank 14 may be heated in the absorption chiller 20 while a cooling fluid (which may comprise a separate portion of the water from the tank 14 or a different cooling fluid) may be cooled in the absorption chiller 20 using the heat from the oxygen enriched air stream provided from the electrolyzer cell system 10, as will be described in more detail below. The cooled oxygen enriched air stream may be exhausted from the absorption chiller 20 via an exhaust conduit 29. In one embodiment, at least part of the oxygen enriched air stream in the exhaust conduit 29 may be recycled into the air inlet stream flowing through in the air inlet conduit 11 to the electrolyzer cell system 10 in order increase the temperature of the air inlet stream.

The cooling fluid from the absorption chiller 20 is provided to a heat exchanger 25 via a cooling conduit 31A. The heat exchanger 25 also receives the hydrogen containing product stream from electrolyzer cell system 10 via the product conduit 22. The cooling fluid may cool the hydrogen containing product stream by heat exchange in the heat exchanger 25. The cooled hydrogen containing product exits the heat exchanger via a product outlet conduit 35. The heated cooling fluid is returned to the absorption chiller 20 from the heat exchanger 25 via a return conduit 31B for re-cooling. The conduits 31A and 31B form a cooling fluid loop 31.

In one embodiment, the heat exchanger 25 may comprise a combined heat exchanger and condenser. In this embodiment, condensed liquid water may be output from the heat exchanger 25 via a water outlet conduit 39. Thus, the hydrogen generating electrolyzer cell system 10 may be integrated with the absorption chiller 20 and the heat exchanger 25 to simultaneously use the waste heat in the oxygen enriched air stream to cool the hydrogen containing product stream.

In one embodiment, the hydrogen containing product stream provided to the heat exchanger 25 via the product conduit 22 may have a temperature between 130 and 180° C. and a water content of 10 to 20% by volume. In contrast, the cooled hydrogen containing product stream output from the heat exchanger 25 via the product outlet conduit 35 may have a temperature between 15 and 30° C. and a water content of 1 to 5% by volume. The oxygen enriched air stream may be cooled in the absorption chiller 20 from a temperature between 250 and 350° C. to a temperature below 250° C., such as a temperature between 100 and 150° C. The cooling fluid may be cooled in the absorption chiller 20 to a temperature between 5 and 10° C., and heated in the heat exchanger 25 to a temperature between 10 and 20° C.

In one embodiment, an optional supplemental heat exchanger 33 may be located on the product conduit 22 upstream of the heat exchanger 25. The supplemental heat exchanger 33 may comprise any suitable heat exchanger, such as an ambient air heat exchanger or a cooling water heat exchanger. For example, the supplemental heat exchanger 33 may comprise the ambient air heat exchanger in which the hydrogen containing product stream is cooled by ambient air. The ambient air heat exchanger may comprise fins located on the outer surface of the product conduit 22 to increase heat exchange between ambient air and the hydrogen containing product stream. The ambient air heat exchanger may also include an air fan or blower which blows ambient air onto the outer surface of the product conduit 22. Alternatively, the supplemental heat exchanger 33 may comprise the cooling water heat exchanger in which cooling water is provided in heat exchange relationship with the product conduit 22. The cooling water may be provided from the cooling water tank 14 or from another cooling water tower located on site. The hydrogen containing product stream flowing through the product conduit 22 may have a temperature between 130 and 180° C. The hydrogen containing product stream may be cooled to a temperature between 20 and 60° C., such as between 50 and 60° C. in the supplemental heat exchanger 33 before being provided to the heat exchanger 25. The supplemental heat exchanger 33 permits the chiller 20 to operate at a lower capacity to cool the hydrogen containing product stream.

All or a portion of the hydrogen generated by the electrolyzer cell system 10 may be provided for use by an end-user facility via the product outlet conduit 35. In one embodiment, the system 30 may generate a cooled hydrogen containing product stream and may supply a storage tank or a chemical plant via the product outlet conduit 35. In various embodiments, the system 30 may be installed as a hydrogen fuel source for a fuel cell power generation system, such that hydrogen is generated during off peak electricity use hours (e.g., at night) and stored for used as a fuel for the fuel cell power generation system to generate electricity during peak electricity demand periods (e.g., during the day). In another embodiment, the system 30 may be installed in a chemical plant to be used as a hydrogen source for one or more chemical processes. The absorption chiller 20 cools the hydrogen for use in the chemical plant or as fuel in a power generation system.

FIG. 1B is a schematic block diagram illustrating an integrated electrochemical cell and absorption chiller system 30, according to various embodiments of the present disclosure. Referring to FIGS. 1A-1B, the electrolyzer cell column 115 located in the hotbox 101 may receive electric power from a power source (e.g., power grid and/or a renewable power source) and operate to produce the hydrogen containing product stream and the oxygen enriched air stream from the steam inlet stream and the air inlet stream. The electrolyzer cell column 115 may receive the air inlet stream from an air blower 12 via the air inlet conduit 11 and the steam inlet stream via the steam inlet conduit 13. The electrolyzer cell column 115 may supply the hydrogen containing product stream to the product conduit 22. The product conduit 22 may include a splitter 116 which may return a portion of the hydrogen containing product stream back to the hotbox 101 via a recycle conduit 103. The recycle conduit 103 may include a recycle blower 117 which recycles a portion of the hydrogen containing product stream into a mixer 118. The mixer 118 mixes the recycled portion of the hydrogen containing product stream with the steam inlet stream in the steam inlet conduit 13. The remaining hydrogen containing product stream may continue through the product conduit 22 to be cooled and dewatered in the heat exchanger/condenser 25, as described below. Although the above description refers to electrolyzer cell column 115, it should be understood that hotbox 101 may contain multiple electrolyzer cell columns 115 that output an aggregated hydrogen containing product stream though product conduit 22.

The oxygen enriched air stream (i.e., the hot air exhaust stream) may be provided via the air exhaust conduit 21 to the absorption chiller 20 at a temperature above 280° C., such as 300 to 320° C. Specifically, as will be described in more detail below with respect to FIG. 3, the hot air exhaust stream may be provided to a desorber (i.e., generator) 301 of the absorption chiller 20. The desorber 301 may apply a working fluid (e.g., a mixture of a liquid refrigerant and a liquid absorbent) to the conduit carrying the hot air exhaust. The heat exchange with the working fluid in the desorber 301 reduces the temperature of the air exhaust stream to below 275° C., such as 100 to 270° C. The cooled air exhaust stream is output from the desorber 301 via the exhaust conduit 29.

The heat exchange with the hot air exhaust stream in the desorber 301 causes the absorbent (e.g., water) to evaporate from the working fluid. The evaporated absorbent (e.g., water vapor) is provided from the desorber 301 to the condenser 303 via a water vapor conduit 321C. The remaining liquid refrigerant (e.g., lithium bromide) is provided from the desorber 301 to the absorber 307 via a conduit 322C, heat exchanger 309 and optional expansion valve 322T.

The evaporated absorbent provided to the condenser 303 is condensed to a liquid absorbent (e.g., liquid water) in the condenser 303. The liquid absorbent is then provided from the condenser 303 through conduit 323C and an expansion valve 323T to the evaporator 305. The evaporator 305 may be maintained at a significantly lower pressure than the desorber 301 and the condenser 303. The sudden decrease in pressure may cause the liquid absorbent entering the evaporator 305 to rapidly cool. Accordingly, the chilled liquid absorbent within the evaporator 305 exchanges heat with the cooling fluid (e.g., water or a water mixture with a glycol and/or alcohol) flowing into the evaporator 305 through the cooling fluid loop 31. For example, the liquid absorbent may be sprayed onto the conduit carrying the cooling fluid. The cooling fluid may be pumped through the cooling fluid loop 31 by a pump 31P. The absorbent may then be returned to the absorber 307 via conduit 324C. The absorbent mixes with the refrigerant in the absorber 307 to reconstitute the working fluid mixture.

The working fluid mixture is then pumped back to the desorber 301 by pump 311 through conduit 318C to start the process again. The working fluid mixture in conduit 318C exchanges heat with the refrigerant in conduit 322C in the heat exchanger 309.

An internal coolant (e.g., water or a mixture of water and an alcohol and/or a glycol) may be pumped by pump 312 between the absorber 307 and the condenser 303 in a cooling conduit loop 319. Both the internal coolant in the cooling conduit loop 319 and the cooling fluid in the cooling loop 31 may both be used to sequentially cool the hydrogen containing product stream in the heat exchanger 25. Thus, the hydrogen product stream from the fuel side of the electrolyzer cell column 115 may be cooled twice in the heat exchanger 25 before exiting the system 30 via the product outlet conduit 35.

In the embodiment of FIG. 1B, the heat exchanger contains two heat exchanger sections 120, 130 and two external condensers 165, 167. The two heat exchanger sections may comprise an upstream cooler 120 heat exchanger and downstream cooler 130 heat exchanger located downstream from the upstream cooler 120 along the hydrogen containing product stream flow direction.

The hydrogen containing product stream may first be cooled in the upstream cooler 120 using the internal coolant (e.g., water) flowing through the cooling conduit loop 319. Thus, the cooling conduit loop 319 extends into the upstream cooler 120 in addition to extending into the condenser 303 and the absorber 307. For example, the internal coolant flowing from the condenser 303 to the upstream cooler 120 may have a temperature between 2 and 10° C. The hydrogen containing product stream flowing through the product conduit 22 may have a temperature between 130 and 180° C. and a water content of 10 to 20% by volume. The temperature of the hydrogen containing product stream may be reduced to between 35 and 50° C. in the upstream cooler 120. This causes a portion of the steam in the hydrogen containing product stream to condense and be removed from the hydrogen containing product stream via a water outlet conduit 127 in a first external condenser 165. The first external condenser 165 may be located downstream of the upstream cooler 120 or it may be physically integrated with the upstream cooler 120. Alternatively, if the optional supplemental heat exchanger 33 is present on the product conduit 22, then the hydrogen containing product stream flowing into the upstream cooler 120 from the supplemental heat exchanger 33 may have a temperature between 20 and 60° C., and the hydrogen containing product stream is cooled to an even lower temperature in the upstream cooler 120.

The cooled and dewatered hydrogen containing product stream then flows from upstream cooler 120 and the first external condenser 165 to the downstream cooler 130 via a connecting conduit 129. The downstream cooler 130 may further cool the hydrogen containing product stream to a lower temperature (e.g., between 5 and 30° C., such as 5 to 10 ^{o}C in case the supplemental heat exchanger 33 is present) by heat exchange with the cooling fluid in the cooling loop 31. Thus, the cooling loop 31 extends between and into the evaporator 305 and the downstream cooler 130. The cooling fluid may enter the downstream cooler 130 at a temperature between 5 and 10° C., and exit the downstream cooler 130 at a temperature between 10 and 20° C. This causes a second portion of the steam in the hydrogen containing product stream to condense and be removed from the hydrogen containing product stream via a second water outlet conduit 39 in the second external condenser 167. The second external condenser 167 may be located downstream of the downstream cooler 130 or it may be physically integrated with the downstream cooler 130. The cooled hydrogen containing product stream is output from the heat exchanger 25 (e.g., from the second external condenser 167) via the product outlet conduit 35 at a temperature between 5 and 30° C. and a water content of 1 to 5% by volume. Water condensate in water outlet conduit 127 and water outlet conduit 39 may be recycled, reheated and input to electrolyzer cell system 10 through steam inlet conduit 13.

By using the internal coolant from the absorption chiller 20 in the upstream cooler 120, the amount of cooling fluid required to cool the hydrogen containing product stream in the downstream cooler 130 can be significantly reduced, and the cost of the operating the absorption chiller 20 is lowered. This also permits the electrolyzer cell system 10 to operate a at lower air factor, such that less heat needs to be recovered from the air exhaust stream in the desorber 301 of the absorption chiller 20.

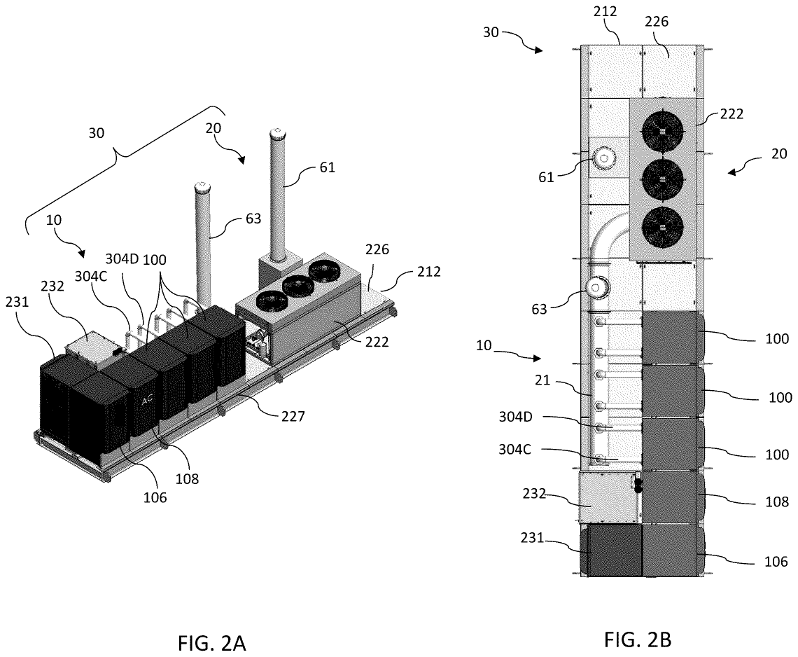

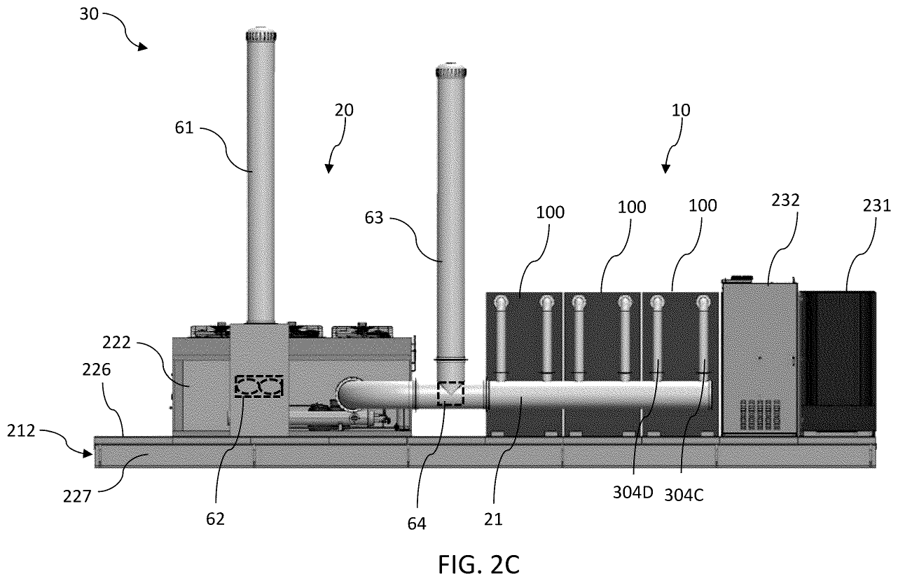

FIG. 2A is a perspective view of an exemplary integrated system 30 comprising an electrolyzer cell system 10 and absorption chiller 20, according to various embodiments of the present disclosure. FIG. 2B is a top view of the integrated system of FIG. 2A. FIG. 2C is a back side view of the system 30 of FIG. 2A. Referring to FIGS. 1A-2C, the system 30 may include the electrolyzer cell system 10 and the absorption chiller 20 located on a common base 212. In the embodiment of FIGS. 2A-2C, the common base 212 may include a skid, such as described in U.S. Patent Application Publication No. 2023/0282867 A1, the entire contents of which are incorporated by reference herein for all purposes. The skid 212 may include an upper surface, which may also be referred to as a deck 226, on which the electrolyzer cell system 10 and the absorption chiller 20 may be supported. In some embodiments, the electrolyzer cell system 10 may be located on a first side of the skid 122, and the absorption chiller 20 may be located on a second side of the skid 212 that is adjacent the first side.

The deck 226 of the skid 212 may be supported above the installation surface (e.g., the ground, a floor, a roof, etc.) by a plurality of support elements 227 that may be connected to the deck 226. The support elements 227 may include a network of rail structures, such as metal (e.g., steel) rails, for example steel I-beams, which may be connected together (e.g., via mechanical fasteners, such as bolts, and/or welded together) to provide a suitably strong support base. As shown in FIGS. 2A and 2C, the support elements 227 may extend around the periphery of the skid 122. Additional support elements 227 (not visible in FIGS. 2A-2C) may extend across the skid 212 beneath the deck 226. The skid 212 may additionally include space between the deck 226 and the installation surface that may be used for electrical and/or plumbing connections to and between the various components of the electrolyzer cell system 10 and/or the absorption chiller 20. At least some of the support elements 227 of the skid 212 may include fork pockets (not shown in FIGS. 2A-2C) for the insertion of the prongs of a forklift for transport, installation and/or removal of the system 30. The skid 212 may additionally include lift points for a crane, such as lift hooks. In some embodiments, the system 30 may be transported to or from an installation site on a flatbed truck over standard roadways, on standard gauge railway cars and/or via shipping containers. The system 30 including the skid 212 may be fully factory assembled and tested prior to deployment to the installation site, which may enable relatively fast and inexpensive installations.

Other suitable configurations for the system 30 may be utilized. For example, the system 30 may be mounted on multiple skids 212. In one embodiment, the electrolyzer cell system 10 may be located on a first skid 212, and the absorption chiller 20 may be located on a second skid 212. The skids 212 may abut one another, or may be separated from one another. In some embodiments, different portions (e.g., electrolyzer module 100 cabinets) of the electrolyzer cell system 10 may be located on different skids 212. In some embodiments, the system 30 may include more than one absorption chiller 20, which may be located on the same skid 212 or on different skids 212.

Other suitable support bases may be used to support all or a portion of the system 30 in addition to or instead of the skid. For example, all or a portion of the system 30 may be supported on a pad formed of suitable structural material(s), such as concrete.

Referring again to FIGS. 2A-2C, the electrolyzer cell system 10 may include one or more electrolyzer modules 100, steam processing modules 106, and power conditioning (e.g., electrical input) modules 108, which may be disposed on the base 212. Each of the modules 100, 106, 108 may include its own housing or cabinet that is accessible by a door. For example, the electrolyzer modules 100 may be fluidly connected with the processing modules 106 through fluid conduits (e.g., pipes) that may be provided on, in, and/or below the base 212, and the power conditioning module 108 may be electrically connected to the electrolyzer modules 100 through wires and/or cables provided on, in, and/or below the base 212.

The steam processing module 106 may include components used for pre-processing the steam, such as, for example, steam filter(s) and/or heaters to increase the temperature of the steam. The steam processing module 106 may be configured to process steam for electrolysis in the electrolyzer cell system 10.

The power conditioning module 108 may include components for converting AC power from a power grid into DC power to power the electrolyzer cells of the electrolyzer cell columns 115 located in the electrolyzer modules 100 of the electrolyzer cell system 10. The components of the power conditioning module 108 may include a rectifier and circuits for managing electrical transients, and a system controller (e.g., a computer or dedicated control logic device or circuit). The power conditioning module 108 may be configured to convert different AC voltages to the DC voltage required by the electrolyzer cell system 10. The power conditioning module 108 may be electrically connected with the one or more electrolyzer modules 100, e.g., via wires provided on, in and/or below the base 212, to provide power to the electrolyzer modules 100.

In some embodiments, the functions of the steam processing module and the power conditioning module may be combined in a single module, such that the above-described steam processing and power conditioning components may be located in a single cabinet or housing.

While three electrolyzer modules 100 are shown in FIGS. 2A-2C, the system 30 may include any number of electrolyzer modules 100. The electrolyzer modules 100 may be arranged in a row as shown in FIGS. 2A-2C. In other embodiments, the electrolyzer cell system 10 may include multiple rows of electrolyzer modules 100. For example, electrolyzer cell system 10 may include two or more rows of electrolyzer modules 100 stacked back to back, end to end, side by side, or on top of one another. The system 30 may also include additional ancillary modules 231 and 232, such as a telemetry module.

As shown in FIGS. 2B and 2C, the system 30 may include the air exhaust conduit 21, which may be relatively wide conduit such as a manifold, configured to provide the oxygen enriched air stream (i.e., air exhaust stream) output from the power modules 100 to the absorption chiller 20. In particular, the air exhaust conduit 21 may be fluidly connected to the electrolyzer modules 100 by module air exhaust conduits 304C, 304D. The air exhaust conduit 21 may direct the air exhaust stream from the electrolyzer modules 100 into a main housing 222 of the absorption chiller 20. The main housing 222 may also include the above described heat exchanger 25. The air exhaust stream may pass through the main housing 222 of the absorption chiller 20 and may exit the system 30 via an exhaust vent stack 61. An induced draft fan 62 (see FIG. 2C) may be utilized to draw the exhaust stream from the main housing 22 of the absorption chiller 20 into the exhaust vent stack 61. The system 30 may also include a bypass vent stack 63 fluidly connected to the air exhaust conduit 21 that may be used to vent all or a portion of the exhaust stream from the system 30 prior to the exhaust stream reaching the absorption chiller 20. A bypass damper 64 (see FIG. 2C) may be used to control the amount of the exhaust stream that is sent to the adsorption chiller 20 versus the amount that is discharged from the system 30 via the bypass vent stack 63. The bypass damper 64 may be located in the air exhaust conduit 21.

FIG. 3 is a schematic block diagram illustrating components of an absorption chiller 20 according to various embodiments of the present disclosure. Referring to FIGS. 1A-3, an absorption chiller 20 is a type of chiller/refrigerant device that may utilize waste heat (e.g., the air exhaust stream) to drive thermodynamic processes that chill a cooling fluid (e.g., water or a mixture of water and alcohol, ethylene glycol and/or propylene glycol) which may then cool another fluid or gas (e.g., the hydrogen containing product stream). The absorption chiller 20 may include a desorber (i.e., a generator) 301, a condenser 303, an evaporator 305, and an absorber 307, which may be located within a common housing, such as the main housing 222 shown in FIGS. 2A-2C. The desorber 301 may be in fluid communication with the condenser 303, and the evaporator 305 may be in fluid communication with the absorber 307. The absorption chiller 20 may additionally include other components, such as a heat exchanger 309, one or more pumps 311, 312 and 313 and various conduits.

A hot air exhaust stream (i.e., the oxygen enriched air stream) 330 from air exhaust conduit 21 may flow through the desorber 301 within one or more chiller exhaust conduits 315. A cooling fluid 331 (e.g., water or a mixture of water and alcohol, ethylene glycol and/or propylene glycol) from the cooling fluid loop 31 flows through the evaporator 305 within one or more cooling fluid conduits 317. Further, an internal coolant (e.g., water) may be pumped by pump 312 between the absorber 307 and the condenser 303 in a cooling conduit loop 319, as shown in FIG. 3.

The absorption chiller 20 may operate by cycling a working fluid (e.g., a refrigerant and absorbent mixture) through the desorber 301, the condenser 303, the evaporator 305, and the absorber 307 as described above regarding FIG. 1B. The working fluid may include a mixture of water and another substance, such as lithium bromide or ammonia. In one non-limiting example, the working fluid may include about 60-65% lithium bromide and about 35-40% water. However, it will be understood that other suitable compositions for the working fluid of the absorption chiller 20 are within the contemplated scope of the disclosure.

The working fluid 318 may partially fill the absorber 307 to form a reservoir 320 of the working fluid 318. The working fluid 318 may be pumped by pump 311 from the reservoir 320 through a working fluid conduit 318C and the heat exchanger 309 and may enter the desorber 301. Within the desorber 301, heat from the hot air exhaust stream 330 flowing through the chiller exhaust conduit(s) 315 may cause the working fluid 318 to separate into its constituent components (i.e., refrigerant and absorber). That is, water (i.e., the absorber) may evaporate from the working fluid 318 to form water vapor 321. The remaining refrigerant 322, which may be mostly lithium bromide, may collect at the bottom of the desorber 301. The separated water vapor 321 may enter the condenser 303, where it may be cooled by the cooling conduit loop 319 and may condense into liquid water 323 that may collect at the bottom of the condenser 303.

The liquid water 323 from the condenser 303 may then flow through the water conduit 323C to the evaporator 305. The evaporator 305 may be maintained at a significantly lower pressure than the desorber 301 and the condenser 303. The liquid water 323 may enter the evaporator 305 via a fixed orifice tube or an expansion valve 323T. The sudden decrease in pressure may cause the liquid water 323 entering the evaporator 305 to rapidly cool. Accordingly, the water 323 within the evaporator 305 may be at a lower temperature than the cooling fluid 331 flowing into the evaporator 305 through the cooling fluid conduit(s) 317. Thermal energy may therefore be transferred through the wall(s) of the cooling fluid conduit(s) 317 from the cooling fluid 331 to the water 323, thereby cooling (i.e., “chilling”) the cooling fluid 331. The “chilled” cooling fluid 331 may then be recirculated to the downstream cooler 130 to cool the hydrogen containing product stream, as described above. The transfer of thermal energy from the cooling fluid 331 to the water 323 in the evaporator 305 may cause a portion of the water 323 in the evaporator 305 to boil and become water vapor 324. Water 323 that collects at the bottom of the evaporator 305 may be recirculated to the fixed orifice tube or an expansion valve 323T over the cooling fluid conduit(s) 317 via a pump 313 to provide further chilling of the cooling fluid 331 and evaporation of the water 323.

The lithium bromide-rich refrigerant 322 from the desorber 301 may flow through refrigerant conduit 322C and the heat exchanger 309. The lithium bromide-rich refrigerant 322 may be cooled in the heat exchanger 309 by the working fluid that is pumped from the absorber 307 to the desorber 301. The lithium bromide-rich refrigerant 322 may then be injected (e.g., sprayed) into the absorber 307. Water vapor 324 from the evaporator 305 may also enter the absorber 307, where the water vapor 324 may be quickly absorbed by the lithium bromide-rich refrigerant 322 due to the strong affinity between the water vapor 324 and the lithium bromide-rich refrigerant 322. The water vapor 324 absorbed with the lithium bromide-rich refrigerant 322 may then be collected at the bottom of the absorber 307 to form a replenished working fluid in the reservoir 320 of the absorber 307. The coolant (e.g., water from cooling water tank 114) pumped through the cooling conduit loop 319 may remove additional heat from the working fluid in the absorber 307. The working fluid 318 in the reservoir 320 of the absorber 307 may then be pumped by pump 311 to the desorber 301 via the working fluid conduit 318C and the heat exchanger 309 to repeat the cycle.

The above embodiment describes one example of the structure and operation of an absorption chiller 20 that may be utilized in an integrated electrolyzer cell system and absorption chiller system 30 according to various embodiments. However, it will be understood that various alternatives to the absorption chiller 20 shown in FIG. 3 may also be utilized. For example, although the absorption chiller 20 illustrated in FIG. 3 is a single-effect absorption chiller, a double-effect absorption chiller that may include a two-stage (e.g., high-temperature and low-temperature) desorber (or a multi-stage desorber) may also be utilized.

Electrolyzer cell systems of the embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A system, comprising:
an electrolyzer cell system configured to receive a steam inlet stream and an air inlet stream and to generate a hydrogen containing product stream and an air exhaust stream; and
an absorption chiller fluidly connected to the electrolyzer cell system, wherein the absorption chiller is configured to receive the air exhaust stream and to cool the hydrogen containing product stream using heat from the air exhaust stream.

2. The system of claim 1, further comprising a heat exchanger configured to cool the hydrogen containing product stream using a cooling fluid output from the absorption chiller.

3. The system of claim 2, further comprising:
air exhaust conduit fluidly connecting an air outlet of the electrolyzer cell system to the absorption chiller, wherein the air exhaust conduit is configured to provide the air exhaust stream from the electrolyzer cell system to the absorption chiller;
a product conduit fluidly connecting a product outlet of the electrolyzer cell system to the heat exchanger, wherein the product conduit is configured to provide the hydrogen containing product stream from the electrolyzer cell system to the heat exchanger; and
a cooling fluid loop fluidly connecting the absorption chiller to the heat exchanger, wherein the cooling fluid loop is configured to provide the cooling fluid to the heat exchanger to cool the hydrogen containing product stream via heat exchange, and to provide the cooling fluid to the absorption chiller to be cooled.

4. The system of claim 3, further comprising:
an external condenser that is integrated with the heat exchanger or that is located downstream of the heat exchanger, and configured to condense liquid water out of the hydrogen containing product stream; and
a water outlet conduit fluidly connected to the condenser and configured to output the liquid water from the external condenser.

5. The system of claim 4, wherein:
the absorption chiller comprises a desorber, a condenser, an evaporator, an absorber, and a cooling conduit loop;
the cooling conduit loop extends into the condenser and the absorber;
the air exhaust conduit is fluidly connected to the absorber; and
the cooling fluid loop is fluidly connected to the evaporator.

6. The system of claim 5, wherein:
the cooling conduit loop is configured to cycle an internal coolant between the condenser and the absorber;
the desorber is configured to exchange heat between the air exhaust stream and a working fluid comprising a mixture of a refrigerant and an absorbent, which causes the absorbent to be evaporated from the working fluid and to flow to the condenser, and causes the refrigerant to flow to the absorber;
the condenser is configured to condense the evaporated absorbent to a liquid absorbent;
the evaporator is configured to receive the liquid absorbent, cool the liquid absorbent by a decrease in pressure, and exchange heat between the cooled absorbent and the cooling fluid in the cooling fluid loop to cool the cooling fluid; and
the absorber is configured to receive the absorbent and to mix the absorbent with the refrigerant to re-form the working fluid.

7. The system of claim 6, wherein:
the heat exchanger comprises an upstream cooler heat exchanger and a downstream cooler heat exchanger located downstream from the upstream cooler heat exchanger along a flow direction of the hydrogen containing product stream; and
the external condenser comprises a first external condenser that is integrated with the upstream cooler heat exchanger or is located between the upstream and the downstream cooler heat exchangers along the flow direction of the hydrogen containing product stream, and a second external condenser that is integrated with the downstream cooler heat exchanger or is located downstream from the downstream cooler heat exchanger along the flow direction of the hydrogen containing product stream;
the cooling conduit loop also extends into the upstream cooler heat exchanger to cool the hydrogen containing product stream by heat exchange with the internal coolant; and
the cooling fluid loop also extends into the downstream cooler heat exchanger to further cool the hydrogen containing product stream by additional heat exchange with the cooling fluid.

8. The system of claim 3, further comprising a supplemental ambient air or cooling water heat exchanger located on the product conduit upstream of the heat exchanger.

9. The system of claim 1, wherein:
the electrolyzer cell system comprises a plurality of hydrogen generation modules;
each of the plurality of hydrogen generation modules comprises a cabinet and a hotbox located within the cabinet; and
each hot box contains at least one electrolyzer cell column.

10. The system of claim 9, wherein:
the at least one electrolyzer cell column comprises a solid oxide electrolyzer cell column; and
the air exhaust conduit comprises an air exhaust manifold that fluidly connects air outlets of the plurality of hydrogen generation modules to the absorption chiller.

11. A method, comprising:
providing a steam inlet stream and an air inlet stream to an electrolyzer cell system to generate a hydrogen containing product stream and an air exhaust stream;
providing the air exhaust stream to an absorption chiller to cool a cooling fluid in the absorption chiller using heat from the air exhaust stream; and
cooling the hydrogen containing product stream by heat exchange with the cooling fluid provided from the absorption chiller.

12. The method of claim 11, wherein the cooling fluid comprises water or a mixture of water with at least one of an alcohol or a glycol.

13. The method of claim 11, further comprising condensing liquid water out of the hydrogen containing product stream cooled by the heat exchange with the cooling fluid.

14. The method of claim 13, wherein the absorption chiller comprises a desorber, a condenser, an evaporator, and an absorber.

15. The method of claim 14, wherein:
an internal coolant is cycled between the condenser and the absorber;
the air exhaust stream exchanges heat with a working fluid comprising a mixture of a refrigerant and an absorbent in the desorber, which causes the absorbent to be evaporated from the working fluid and to flow to the condenser, and causes the refrigerant to flow to the absorber;
the evaporated absorbent is condensed to a liquid absorbent in the condenser;
the liquid absorbent is cooled in the evaporator by a decrease in pressure, and exchanges heat with the cooling fluid to cool the cooling fluid; and
the absorbent is mixed with the refrigerant in the absorber to re-form the working fluid.

16. The method of claim 15, further comprising:
cooling the hydrogen containing product stream by heat exchange with the internal coolant is a first heat exchanger;
condensing liquid water from the cooled hydrogen containing product stream;
further cooling the hydrogen containing product stream by additional heat exchange with the cooling fluid in a second heat exchanger downstream of the first heat exchanger; and
condensing additional liquid water from the further cooled hydrogen containing product stream.

17. The method of claim 16, wherein:
the hydrogen containing product stream is provided to the first heat exchanger at a temperature of between 130 and 180° C. and a water content of 10 to 20% by volume;
the hydrogen containing product stream is cooled to a temperature between 35 and 50° C. in the first heat exchanger;
the hydrogen containing product stream is further cooled to a temperature between 5 and 30° C. in the second heat exchanger and is discharged with a water content of 1 to 5% by volume;
the air exhaust stream is provided into the absorption chiller at a temperature above 280° C.; and
the air exhaust stream is output from the absorption chiller at a temperature below 275° C.

18. The method of claim 11, wherein:
the electrolyzer cell system comprises a plurality of hydrogen generation modules;
each of the plurality of hydrogen generation modules comprises a cabinet and a hotbox located within the cabinet; and
each hot box contains at least one electrolyzer cell column.

19. The method of claim 18, wherein:
the air exhaust streams from the plurality of hydrogen generation modules are combined in an air exhaust manifold and provided to the absorption chiller through the air exhaust manifold; and
the at least one electrolyzer cell column comprises a solid oxide electrolyzer cell column.

20. The method of claim 11, further comprising cooling the hydrogen containing product stream in a supplemental heat exchanger using ambient air or cooling water upstream of the heat exchanger.
